(19) United States
(12) Patent Application Publication
(10) Pub. No.: US 2013/0147704 A1
(43) Pub. Date: Jun. 13, 2013

(54) ELECTRONIC DEVICE PROVIDING SHAKE GESTURE IDENTIFICATION AND METHOD

(71) Applicants: HSUAN-HAO KUO, Tu-Cheng (TW); MING-CHUAN KAO, Tu-Cheng (TW); JEN-HSIUNG CHARNG, Tu-Cheng (TW)

(72) Inventors: HSUAN-HAO KUO, Tu-Cheng (TW); MING-CHUAN KAO, Tu-Cheng (TW); JEN-HSIUNG CHARNG, Tu-Cheng (TW)

(21) Appl. No.: 13/667,007

(22) Filed: Nov. 2, 2012

(30) Foreign Application Priority Data
Dec. 9, 2011 (CN) 201110409140.0

(51) Int. Cl. G06F 3/033

(52) U.S. Cl. 345/156

(57) ABSTRACT

A method to identify a shake gesture using an electronic device. The electronic device reads reference acceleration values from an accelerometer of the electronic device when a user shakes the electronic device to establish the shake gesture. The electronic device generates the shake gesture by a sorting algorithm according to the reference acceleration values and associates the shake gesture with an application. The electronic device starts the application corresponding to the shake gesture.

### BACKGROUND

1. Technical Field

Embodiments of the present disclosure relate to electronic device management systems and methods, and particularly to an electronic device providing shake gesture identification and a method for using the shake gesture identification.

2. Description of Related Art

Because electronic devices (e.g., a smart phone) are often used as personal organizers, they frequently offer a plurality of applications, such as applications for games, music, calendars, and calculators. However, at present, the applications are started by clicking associated icons or touching the associated icons, which is not flexible. Therefore, there is room for improvement in the art.

### BRIEF DESCRIPTION OF THE DRAWINGS

FIG. 1 is a schematic diagram of one embodiment of an electronic device including a shake gesture identification system.

FIG. 2 is a block diagram of one embodiment of the shake gesture identification system in FIG. 1.

FIG. 3 is a flowchart of one embodiment of a method for identifying the shake gestures on the electronic device, such as, for example, that of FIG. 1.

FIG. 4 illustrates one embodiment of a left-vertical shake gesture.

FIG. 5 illustrates one embodiment of a right-vertical shake gesture.

FIG. 6 illustrates one embodiment of a leftward shake gesture.

FIG. 7 illustrates one embodiment of a rightward shake gesture.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean at least one.

In general, the word “module,” as used herein, refers to logic embodied in hardware or firmware, or to a collection of software instructions, written in a programming language. One or more software instructions in the modules may be embedded in firmware, such as in an erasable programmable read only memory (EPROM). The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

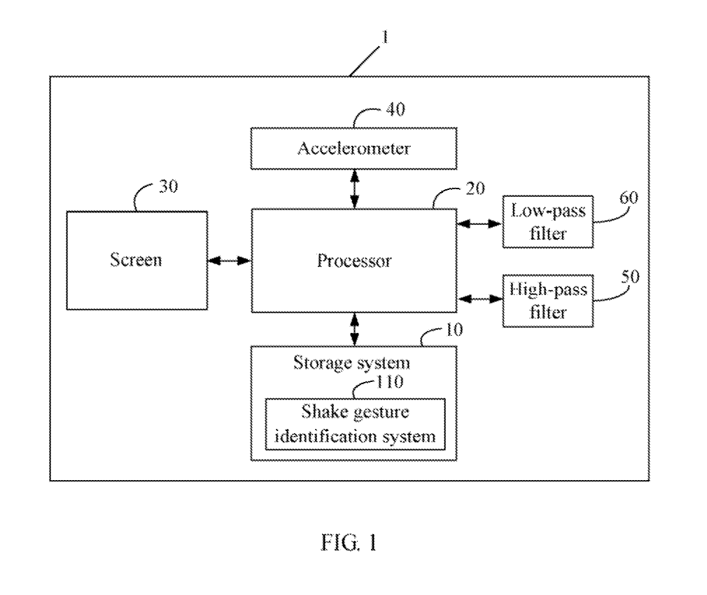

FIG. 1 is a block diagram of one embodiment of an electronic device 1 including the shake gesture identification system 110. The shake gesture identification system 110 may be used to identify shake gestures when the electronic device 1 is shaken by a user. In one embodiment, the electronic device 1 includes a storage system 10, a processor 20, a screen 30, an accelerometer 40, a high-pass filter 50, and a low-pass filter 60. The storage system 10, the screen 30, an accelerometer 40, the high-pass filter 50 and the low-pass filter 60 are connected to the processor 20. The processor may be, but is not limited to, a central processing unit (CPU) or a system on a chip (SOC).

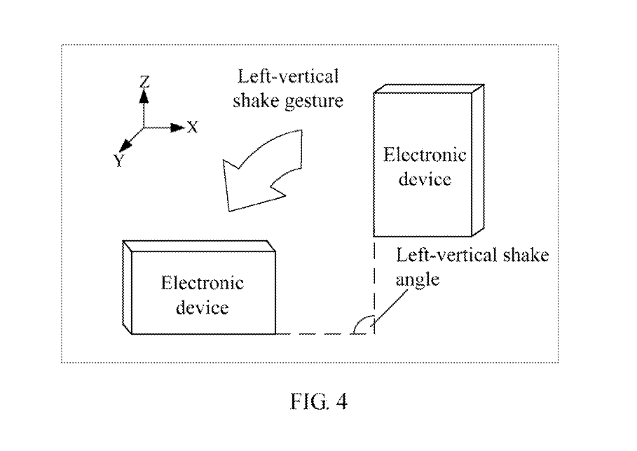

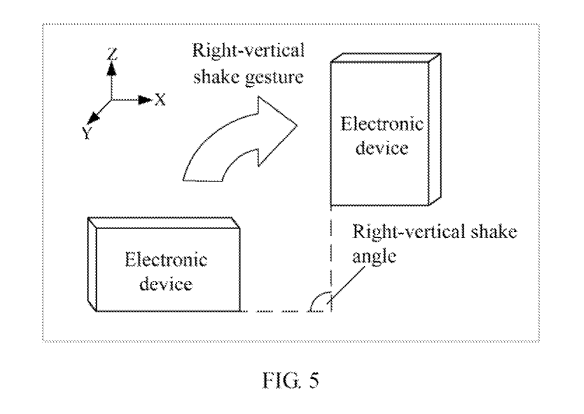

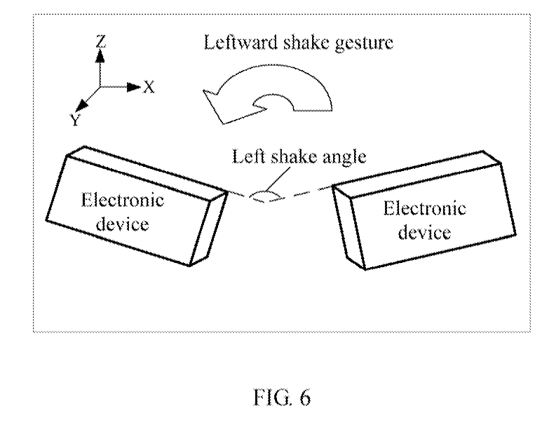

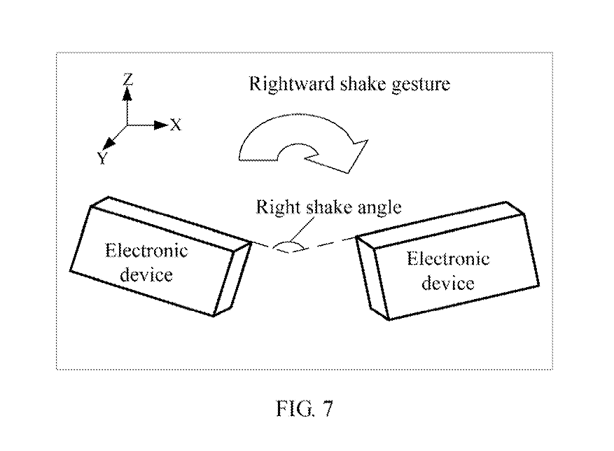

The storage system 10 stores one or more shake gestures. Each of the one or more shake gestures may be associated with an application (e.g., a game) installed in the electronic device 1. The one or more shake gestures include a left-vertical shake gesture, a right-vertical shake gesture, a leftward shake gesture, and a rightward shake gesture. As shown in FIG. 4, taking this figure as an example, the lower left corner of the electronic device 1 is moved in a negative X-direction and also in a negative Z-direction, the left side is moved through near 90 degrees to lie on its side. The left-vertical shake gesture is a gesture when a user vertically shakes the electronic device 1 leftward by a left-vertical shake angle. As shown in FIG. 5, the right-vertical shake gesture is the gesture when the user vertically shakes the electronic device 1 rightward by the right-vertical shake angle. The left-vertical shake angle and the right-vertical shake angle may fall within a range. The range may start at eighty five degrees angle and end at ninety five degrees angle. As shown in FIG. 6, the leftward shake gesture is the gesture when the user shakes the electronic device 1 leftward by a left shake angle. As shown in FIG. 7, the rightward shake gesture is the gesture when the user shakes the electronic device 1 from rightward by a right shake angle. The left shake angle and the right shake angle may fall within the range. The range may starts at one hundred and twenty degrees angle and ends at one hundred and eighty degrees.

In one embodiment, the storage system 10 may be an internal storage system card or an external storage system card, such as a smart media card (SMC), a secure digital card (SDC), a compact flash card (CFC), a multi media card (MMC), a storage system stick (MS), an extreme digital card (XDC), or a trans flash card (TFC). Depending on the embodiment, the electronic device 1 may be a mobile phone, a personal digital assistant (PDA), a handheld game player, a digital camera, or any other portable electronic device.

The screen 30 is operable to display an application (e.g., show the dialog box) when the electronic device 1 is shaken by a user to start the application. Regarding how to start application by shaking the electronic device 1 will be described below.

The accelerometer 40 generates acceleration values when the user shakes the electronic device 1. In one embodiment, the accelerometer 40 generates fifty acceleration values per second when the user shakes the electronic device 1. Each acceleration value includes an acceleration value in the X-direction, an acceleration value in the Y-direction, and an acceleration value in the Z-direction.

The high-pass filter 50 passes high-frequency signals with frequencies higher than a cutoff frequency of the high-pass filter 50. In one embodiment, the high-frequency signals are obtained from the accelerometer 40 and each high-frequency signal corresponds to an acceleration value.

The low-pass filter 60 passes low-frequency signals with frequencies lower than the cutoff frequency of the low-pass filter 50. As mentioned above, the low-frequency signals are obtained from the accelerometer 40 and each low-frequency signal corresponds to an acceleration value.

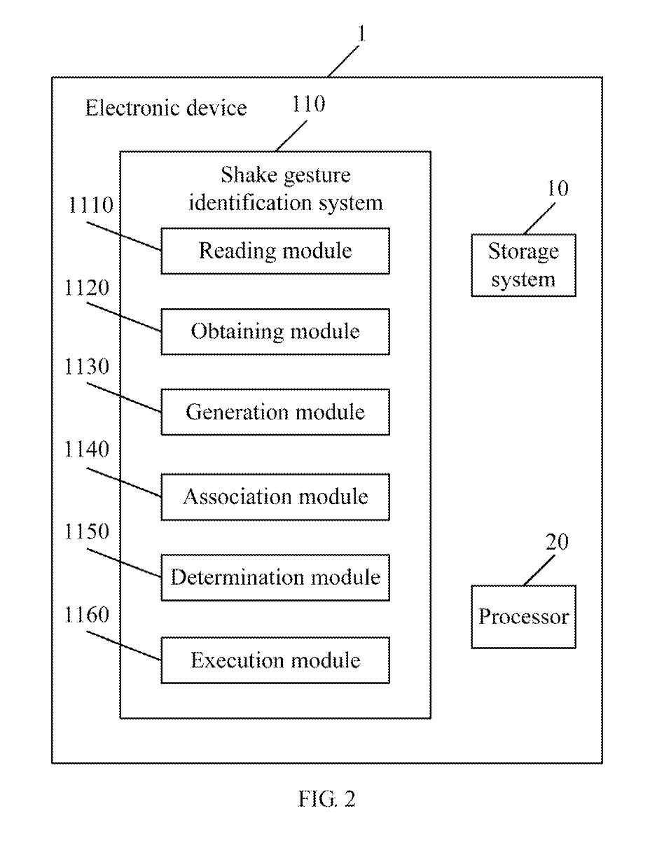

FIG. 2 is a block diagram of one embodiment of the shake gesture identification system 110 in FIG. 1. In one embodiment, the shake gesture identification system 110 includes a reading module 1110, an obtaining module 1120, a generation module 1130, an association module 1140, a determination module 1150, and an execution module 1160. The modules 1110-1160 may include computerized code in the form of one or more programs that are stored in the storage system 10. The computerized code includes instructions that are executed by the at least one processor 20 to provide functions for modules 1110-1160.

The reading module 1110 reads reference acceleration values from the accelerometer 40 when the user shakes the electronic device 1. The reference acceleration values are also generated by the accelerometer 40 when the user shakes the electronic device 1 to establish the shake gesture. In one embodiment, each shake gesture is established by shaking the electronic device 1 by the user one time.

The obtaining module 1120 obtains a predetermined number of the reference acceleration values. In one embodiment, if the accelerometer 40 generates one hundred reference acceleration values, the obtaining module 1120 may obtain twenty reference acceleration values for use from the one hundred reference acceleration values.

The generation module 1130 generates the conditions for identifying a shake gesture by a sorting algorithm according to the predetermined number of the reference acceleration values. The sorting algorithm may be, but is not limited to, a Bayesian algorithm, a decision tree algorithm, and an artificial neural network algorithm. The shake gesture includes the left-vertical shake gesture, the right-vertical shake gesture, the leftward shake gesture, or the rightward shake gesture.

The left-vertical shake gesture satisfies the conditions as follows: the average absolute value of each reference acceleration value is greater than or equal to a first predetermined value (e.g., 0.604767 m/s²). The twelfth reference acceleration value is processed by the low-pass filter 60, and the twelfth reference acceleration value in the X-direction less than a second predetermined value (e.g., minus 0.7249232 m/s²), the twentieth reference acceleration value is processed by the low-pass filter 60, and the twentieth reference acceleration value in the X-direction is lower than a third predetermined value (e.g., minus 0.522402 m/s²). The table below shows the conditions for identifying the left-vertical shake gesture.

| | | | |
|---|---|---|---|
| 12^{th} reference acceleration | X-direction | Low-pass | Greater than |
| value | | filter | −0.724923 m/s² |
| 20^{th} reference acceleration | X-direction | Low-pass | Less than |
| value | | filter | −0.522402 m/s² |

The right-vertical shake gesture satisfies the conditions as follows: the average absolute value of each reference acceleration value is greater than or equal to the first predetermined value (e.g., 0.604767 m/s²). The twelfth reference acceleration value is processed by the low-pass filter 60, and the twelfth reference acceleration value in the X-direction is less than the second predetermined value (e.g., minus 0.7249232 m/s²), the twentieth reference acceleration value is processed by the low-pass filter 60, and the twentieth reference acceleration value in the X-direction is greater than the third predetermined value (e.g., minus 0.522402 m/s²). The table below shows the conditions for identifying the right-vertical shake gesture.

| | | | |
|---|---|---|---|
| 12^{th} reference acceleration | X-direction | Low-pass | Greater than |
| value | | filter | −0.724923 m/s² |
| 20^{th} reference acceleration | X-direction | Low-pass | Greater than |
| value | | filter | −0.522402 m/s² |

The leftward shake gesture may include three situations.

A first situation of the leftward shake gesture is as follows: the average absolute value of each reference acceleration value is greater than or equal to the first predetermined value (e.g., 0.604767 m/s²). The twelfth reference acceleration value is processed by the low-pass filter 60, and the twelfth reference acceleration value in the X-direction in is less than the second predetermined value (e.g., minus 0.7249232 m/s²). The tenth reference acceleration value is processed by the low-pass filter 60, and the tenth reference acceleration value in the Z-direction in is greater than the third predetermined value (e.g., minus 0.384571 m/s²). The eighth reference acceleration value is processed by the high-pass filter 50, and the eighth reference acceleration value in the Z-direction is less than the fourth predetermined value (e.g., minus 0.992135). The table below shows the conditions for identifying the leftward shake gesture in the first situation.

| | | | |
|---|---|---|---|
| 12^{th} reference acceleration | X-direction | Low-pass | Less than |
| value | | filter | −0.724923 m/s² |
| 10^{th} reference acceleration | Z-direction | Low-pass | Greater than |
| value | | filter | −0.384571 m/s² |
| 8^{th} reference acceleration | Z-direction | High-pass | Less than |
| value | | filter | −0.992135 m/s² |

A second situation of the leftward shake gesture is as follows: the average absolute value of each reference acceleration value is greater than or equal to the first predetermined value (e.g., 0.604767 m/s²). The twelfth reference acceleration value is processed by the low-pass filter 60, and the twelfth reference acceleration value in the X-direction in is less than the second predetermined value (e.g., minus 0.7249232 m/s²). The tenth reference acceleration value is processed by the low-pass filter 60, and the tenth reference acceleration value in the Z-direction is less than the third predetermined value (e.g., minus 0.384571 m/s²). The eleventh reference acceleration value is processed by the low-pass filter 60, and the eleventh reference acceleration value in the Y-direction is greater than a fourth predetermined value (e.g., 0.206395 m/s²). The table below shows the conditions for identifying the leftward shake gesture in the second situation.

| | | | |
|---|---|---|---|
| 12^{th} reference acceleration | X-direction | Low-pass | Less than |
| value | | filter | −0.724923 m/s² |
| 10^{th} reference acceleration | Z-direction | Low-pass | Less than |
| value | | filter | −0.384571 m/s² |
| 11^{th} reference acceleration | Y-direction | Low-pass | Greater than |
| value | | filter | 0.206395 m/s² |

A third situation of the leftward shake gesture is as follows: the average absolute value of each reference acceleration value is greater than or equal to the first predetermined value (e.g., 0.604767 m/s²). The twelfth reference acceleration value is processed by the low-pass filter 60, and the twelfth reference acceleration value in the X-direction is less than the second predetermined value (e.g., minus 0.7249232 m/s²). The tenth reference acceleration value is processed by the low-pass filter 60, and the tenth reference acceleration value in the Z-direction in is less than the third predetermined value (e.g., minus 0.384571 m/s²). The eleventh reference acceleration value is processed by the low-pass filter 60, and the eleventh reference acceleration value in the Y-direction in is less than the fourth predetermined value (e.g., 0.206395 m/s²). The fourth reference acceleration value is processed by the high-pass filter 50, and the fourth reference acceleration value in the Z-direction is greater than a fifth predetermined value (e.g., 0.013021 m/s²). The table below shows the conditions for identifying the leftward shake gesture in the third situation.

| | | | |
|---|---|---|---|
| 12^{th} reference acceleration | X-direction | Low-pass | Less than |
| value | | filter | −0.724923 m/s² |
| 10^{th} reference acceleration | Z-direction | Low-pass | Less than |
| value | | filter | −0.384571 m/s² |
| 11^{th} reference acceleration | Y-direction | Low-pass | Less than |
| value | | filter | 0.206395 m/s² |
| 4^{th} reference acceleration | Z-direction | High-pass | Greater than |
| value | | filter | 0.013021 m/s² |

The rightward shake gesture may include two situations.

The first situation of the rightward shake gesture is as follows: the average absolute value of each reference acceleration value is greater than or equal to the first predetermined value (e.g., 0.604767 m/s²). The twelfth reference acceleration value is processed by the low-pass filter 60, and the twelfth reference acceleration value in the X-direction in is less than the second predetermined value (e.g., minus 0.7249232 m/s²). The tenth reference acceleration value is processed by the low-pass filter 60, and the tenth reference acceleration value in the Z-direction is greater than the third predetermined value (e.g., minus 0.384571 m/s²). The eighth reference acceleration value is processed by the high-pass filter 50, and the eighth reference acceleration value in the Z-direction is greater than the fourth predetermined value (e.g., minus 0.992135 m/s²). The table below shows the conditions for identifying the rightward shake gesture in the first situation.

| | | | |
|---|---|---|---|
| 12^{th} reference acceleration | X-direction | Low-pass | Less than |
| value | | filter | −0.724923 m/s² |
| 10^{th} reference acceleration | Z-direction | Low-pass | Greater than |
| value | | filter | −0.384571 m/s² |
| 8^{th} reference acceleration | Z-direction | High-pass | Greater than |
| value | | filter | −0.992135 m/s² |

The second situation of the rightward shake gesture is as follows: the average absolute value of each reference acceleration value is greater than or equal to the first predetermined value (e.g., 0.604767 m/s²). The twelfth reference acceleration value is processed by the low-pass filter 60, and the twelfth reference acceleration value in the Page of X-direction is less than the second predetermined value (e.g., minus 0.7249232 m/s²). The tenth reference acceleration value is processed by the low-pass filter 60, and the tenth reference acceleration value in the Z-direction in is less than the third predetermined value (e.g., minus 0.384571 m/s²). The eleventh reference acceleration value is processed by the low-pass filter 60, and the eleventh reference acceleration value in the Y-direction in is less than the fourth predetermined value (e.g., 0.206395 m/s²). The fourth reference acceleration value is processed by the high-pass filter 50, and the fourth reference acceleration value in the Z-direction in is less than a fifth predetermined value (e.g., 0.013021 m/s²). The table below shows the conditions for identifying the rightward shake gesture in the second situation.

| | | | |
|---|---|---|---|
| 12^{th} reference acceleration | X-direction | Low-pass | Less than |
| value | | filter | −0.724923 m/s² |
| 10^{th} reference acceleration | Z-direction | Low-pass | Less than |
| value | | filter | −0.384571 m/s² |
| 11^{th} reference acceleration | Y-direction | Low-pass | Less than |
| value | | filter | 0.206395 m/s² |
| 4^{th} reference acceleration | Z-direction | High-pass | Less than |
| value | | filter | 0.013021 m/s² |

The association module 1140 associates the shake gesture with an application. For example, the association module 1140 associates the rightward shake gesture with the application which is operable to play music.

The reading module 1110 reads real-time acceleration values from the accelerometer when the user shakes the electronic device. The real-time acceleration values are also generated by the accelerometer 40 when the user shakes the electronic device 1 to identify the shake gesture.

The determination module 1150 determines if the real-time acceleration values match the conditions of identifying the shake gesture.

The execution module 1160 starts the application corresponding to the shake gesture if the real-time acceleration values match the shake gesture.

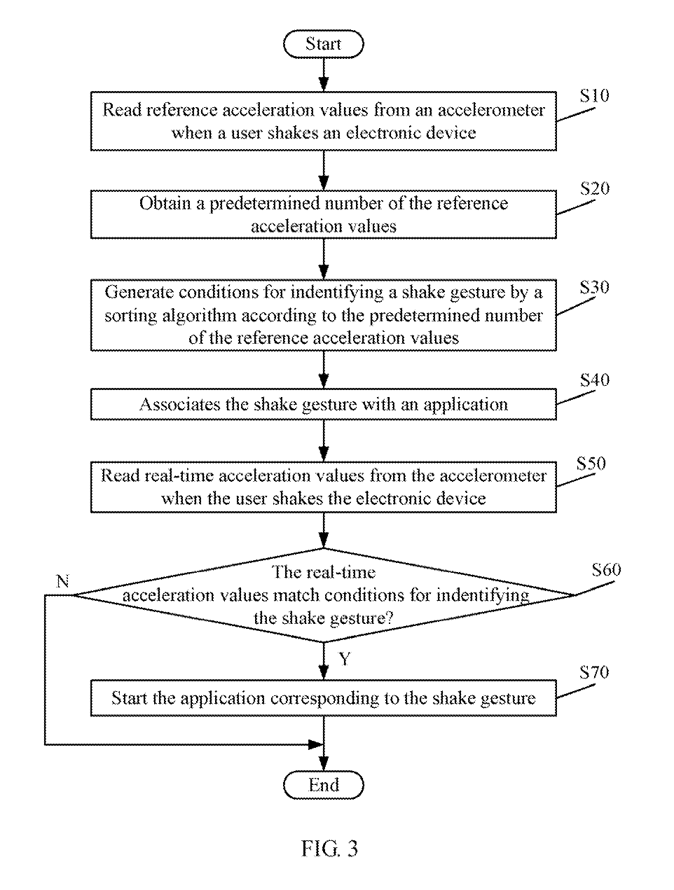

FIG. 3 is a flowchart of one embodiment of a method for identifying the shake gestures on the electronic device in FIG. 1. Depending on the embodiment, additional steps may be added, while others deleted, and the steps may also be executed in a different order than described.

In step S10, the reading module 1110 reads reference acceleration values from the accelerometer 40 when the user shakes the electronic device 1. The reference acceleration values are also generated by the accelerometer 40 when the user shakes the electronic device 1 to establish the shake gesture. As mentioned above, each shake gesture is established by shaking the electronic device 1 by the user one time.

In step S20, the obtaining module 1120 obtains a predetermined number of the reference acceleration values. For example, the obtaining module 1120 obtains twenty reference acceleration values for use from the one hundred reference acceleration values.

In step S30, the generation module 1130 generates conditions for identifying a shake gesture by a sorting algorithm according to the predetermined number of the reference acceleration values. As mentioned above, the sorting algorithm may be, but is not limited to, a Bayesian algorithm, a decision tree algorithm, and an artificial neural network algorithm.

In step S40, the association module 1140 associates the shake gesture with an application. For example, the application relating to playing music is associated with the rightward shake gesture.

In step S50, the reading module 1110 reads real-time acceleration values from the accelerometer when the user shakes the electronic device. As mentioned above, the real-time acceleration values are also generated by the accelerometer 40 when the user shakes the electronic device 1 to identify the shake gesture.

In step S60, the determination module 1150 determines if the real-time acceleration values match the conditions of identifying the shake gesture. If the real-time acceleration values match the shake gesture, for example, the rightward shake gesture, the procedure goes to step 70. Otherwise, if the real-time acceleration values do not match the shake gesture, the procedure ends.

In step S70, the execution module 1160 starts the application corresponding to the shake gesture. For example, the execution module 1160 starts the application to play music when the real-time acceleration values match the rightward shake gesture.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. An electronic device, comprising:
at least one processor;
a storage system; and
one or more programs stored in the storage system and being executable by the at least one processor, the one or more programs comprising:
a reading module reads reference acceleration values from an accelerometer of the electronic device when a user shakes the electronic device to establish a shake gesture;
a generation module generates conditions for identifying the shake gesture by a sorting algorithm according to the reference acceleration values;
an association module associates the shake gesture with an application;
the reading module further reads real-time acceleration values from the accelerometer of the electronic device when the user shakes the electronic device after the shake gesture has been established; and
an execution module starts the application corresponding to the shake gesture when the real-time acceleration values match the conditions of identifying the shake gesture.

2. The electronic device of claim 1, wherein each reference acceleration value and real-time acceleration value comprise a value in an X-direction, a value in a Y-direction, and a value in a Z-direction.

3. The electronic device of claim 1, wherein the shake gesture is selected from the group consisting of a left-vertical shake gesture, a right-vertical shake gesture, a leftward shake gesture, and a rightward shake gesture.

4. The electronic device of claim 1, wherein the sorting algorithm is selected from the group consisting of a Bayesian algorithm, a decision tree algorithm, and an artificial neural network algorithm.

5. The electronic device of claim 1, further comprising an obtaining module operable to obtain a predetermined number of the reference acceleration values.

6. The electronic device of claim 1, further comprising a determination module operable to determine if the real-time acceleration values match conditions for identifying the shake gesture.

7. The electronic device of claim 1, wherein the storage system is selected from the group consisting of a smart media card (SMC), a secure digital card (SDC), a compact flash card (CFC), a multi media card (MMC), a storage system stick (MS), an extreme digital card (XDC), and a trans flash card (TFC).

8. A method for identifying a shake gesture in an electronic device, the method comprising:
reading reference acceleration values from an accelerometer of the electronic device when a user shakes the electronic device to establish a shake gesture;
generating conditions for identifying the shake gesture by a sorting algorithm according to the reference acceleration values;
associating the shake gesture with an application;
reading real-time acceleration values from the accelerometer of the electronic device when the user shakes the electronic device after the shake gesture has been established; and
starting the application corresponding to the shake gesture when the real-time acceleration values match the conditions of identifying the shake gesture.

9. The method of claim 8, wherein each reference acceleration value and real-time acceleration value comprise a value in an X-direction, a value in a Y-direction, and a value in a Z-direction.

10. The method of claim 8, wherein the shake gesture is selected from the group consisting of a left-vertical shake gesture, a right-vertical shake gesture, a leftward shake gesture, and a rightward shake gesture.

11. The method of claim 8, wherein the sorting algorithm is selected from the group consisting of a Bayesian algorithm, a decision tree algorithm, and an artificial neural network algorithm.

12. The method of claim 8, wherein the method further comprises:
obtaining a predetermined number of the reference acceleration values.

13. The method of claim 8, wherein the method further comprises:
determining if the real-time acceleration values match the shake gesture.

14. The method of claim 8, wherein the storage system is selected from the group consisting of a smart media card (SMC), a secure digital card (SDC), a compact flash card (CFC), a multi media card (MMC), a storage system stick (MS), an extreme digital card (XDC), and a trans flash card (TFC).

15. A non-transitory storage medium having stored thereon instructions that, when executed by an electronic device, cause the electronic device to perform a method for identifying a shake gesture in an electronic device, the method comprising:
reading reference acceleration values from an accelerometer of the electronic device when a user shakes the electronic device to establish a shake gesture;
generating conditions for identifying the shake gesture by a sorting algorithm according to the reference acceleration values;
associating the shake gesture with an application;
reading real-time acceleration values from the accelerometer of the electronic device when the user shakes the electronic device after the shake gesture has been established; and
starting the application corresponding to the shake gesture when the real-time acceleration values match the conditions of identifying the shake gesture.

16. The non-transitory storage medium of claim 15, wherein each reference acceleration value and real-time acceleration value comprise a value in an X-direction, a value in a Y-direction, and a value in a Z-direction.

17. The non-transitory storage medium of claim 15, wherein the shake gesture is selected from the group consisting of a left-vertical shake gesture, a right-vertical shake gesture, a leftward shake gesture, and a rightward shake gesture.

18. The non-transitory storage medium of claim 15, wherein the sorting algorithm is selected from the group consisting of a Bayesian algorithm, a decision tree algorithm, and an artificial neural network algorithm.

19. The non-transitory storage medium of claim 15, wherein the method further comprises:
obtaining a predetermined number of the reference acceleration values.

20. The non-transitory storage medium of claim 15, wherein the method further comprises:
determining if the real-time acceleration values match the shake gesture.
